(19) United States
(12) Patent Application Publication
(10) Pub. No.: US 2010/0318447 A1
(43) Pub. Date: Dec. 16, 2010

(54) PRE-FUNDED SETTLEMENT

(75) Inventor: Timothy P. McKinney, Overijse (BE)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 12/482,068

(22) Filed: Jun. 10, 2009

(51) Int. Cl. G06Q 40/00; G06Q 10/00

(52) U.S. Cl. 705/30; 705/39; 705/38; 705/37

(57) ABSTRACT

A system and method for advancing cash to merchants participating in a consumer card-based payment network. The system/method provides low cost working capital to merchants by aggregating lending offers from perspective lenders with borrowing applications from merchants to match the supply of capital with the demand for loans whereby an effective interest rate can be determined. The risk profile associated with a particular merchant, as well as the loan amount and duration, can also be considered when determining the effective interest rate.

### BACKGROUND OF THE INVENTION

The present invention relates to a system and method for advancing cash to merchants participating in a consumer card-based payment network and, more particularly, to a system and method for supplying low cost working capital to merchants secured by anticipated future payment volume.

Both credit card and debit cards are commonly used in the retail environment for the purchase of goods and/or services. Such cards are popular with consumers, and merchants accept these cards as a necessary part of doing business i.e., they are ubiquitous and provide an effective substitute for cash and checks.

Those skilled in the art will recognize that at present it is difficult to encourage merchants to promote usage of credit/debit cards over cash during a transaction for goods/services. Although the handling of cash has costs associated therewith, many merchants (particularly larger merchants) have already implemented procedures for effectively and efficiently handling this cash. With interest rates already low, and likely to remain low for the foreseeable future, the argument that card-based transactions provide a financial advantage to the merchant because of faster account settlement is even less persuasive. As a result, it has become more difficult for a network provider (e.g. Mastercard) to promote usage of its MasterCard-branded payment cards as an alternative to cash.

Merchants are also constantly concerned about cash flow. More particularly, there is a constant “war on inventory” in the world of retail where every effort is made to accelerate gross revenue, while minimizing cash tied up in the cost-of-goods. In many retail environments, the expected future sales can be fairly well predicted based on the historical sales data for that company, or for that particular store branch, or for that particular month of the year, etc. In other words, every merchant develops a sales history, which tends to provide a fairly accurate prediction of expected future sales. With respect to merchants who accept credit/debit cards, this historical sales data may already be electronically captured with such entities such as the network provider and/or processor.

In the past, merchants who required a loan have pledged their future sales as a security on such loan, and have agreed to repay such loan by automatically having a merchant processor (which is settling a credit/debit card based transaction) pay a predetermined portion directly to the lender, with the remaining portion being sent to the merchant. Such a system is described in U.S. Pat. No. 6,826,544. However, it will be appreciated by those skilled in the art that the system/method disclosed in the '544 patent is directed to the repayment of a loan—not to the process of matching borrowers and lenders, not to the process of aggregating supply and demand and not to the process of assessing risk. In other words, the system/method of the '544 patent is limited to a way of repaying a loan, typically a closed end loan written at a high interest rate, using future electronic payments.

There is therefore a need in the art for a system/method for providing low cost working capital to merchants, such system/method matching borrowers with lenders, aggregating supply and demand, and allowing lenders to both assess risk and to diversify risk. There is a further need in the art for a system/method which would allow merchants to obtain this working capital at market based rates, and which would provide an incentive for such merchants to sponsor/promote particular credit/debit cards. Finally, there is a need in the art for a system which would allow lenders to readily analyze and assess the risk associated with lending to a particular merchant or pool of merchants.

### SUMMARY OF THE INVENTION

The present invention, which addresses the needs of the prior art, relates to a method of advancing cash to merchants participating in a consumer card-based payment network from a pool of available capital. The method includes the step of aggregating within the payment network all lending offers from prospective lenders with all borrowing applications from the merchants to match the supply of capital from the lenders with the demand for loans from the merchants whereby an effective interest rate can be determined. The method includes the further step of advancing a pre-selected amount of cash to at least one qualified merchant at the effective interest rate. Finally, the method includes the step of repaying the lenders by diverting a pre-determined portion of funds traveling through the payment network and which are payable to the qualified merchant to the lenders.

In one preferred embodiment, the method includes the further step of providing historical sales data associated with at least one of the merchants to at least one of the prospective lenders to allow risk assessment of the merchant to be undertaken by the prospective lender. In another preferred embodiment, historical sales associated with a pool of merchants is provided to the lenders for a risk assessment.

The present invention also relates to a system for advancing cash to a merchant participating in a consumer card-based payment network. The system includes a payment network for handling consumer card-based retail transactions. The network includes a settlement engine for handling reconciliation and reporting requirements, a data warehouse for collecting and storing payment history from merchants participating in the network and a dynamics syndication platform for receiving lending offers from prospective lenders and for receiving borrowing applications from prospective borrowers. The platform is configured to aggregate the lending offers with the borrowing applications to match the supply of capital from the lenders with the demand for loans from the borrowers whereby an effective interest rate may be determined. The settlement engine is configured to advance a preselected amount of cash to at least one qualified borrower at the effective interest rate. Finally, the settlement engine is configured to divert a predetermined portion of funds traveling through the network and which are payable to the qualified borrower to the lender.

As a result, the present invention provides a system/method for providing low-cost working capital to merchants by matching borrowers with lenders, aggregating supply and demand, and allowing lenders to both assess risk and diversify risk. The present invention further provides a system/method which allows merchants to obtain working capital at market-based rates, and which provides an incentive for such merchants to sponsor/promote particular credit/debit cards. Finally, the present invention provides a system/method which allows prospective lenders to readily analyze and assess the risk associated with lending to a particular merchant or pool of merchants.

### BRIEF DESCRIPTION OF THE DRAWINGS

FIG. 1 is a schematical view of the pre-funded settlement system of the present invention interacting with a plurality of merchants and lenders;

FIG. 2 is a schematical view of the components of the pre-funded settlement system of FIG. 1;

FIG. 3 is a schematical view of a closed-end anticipated sales obligation funding process;

FIG. 4 is a graph showing theoretical rate curves for different funding durations;

FIG. 5 is a schematical view showing two different repayment plans; and

FIG. 6 is a graph showing cumulative sales for a preselected period of time.

### DETAILED DESCRIPTION OF THE INVENTION

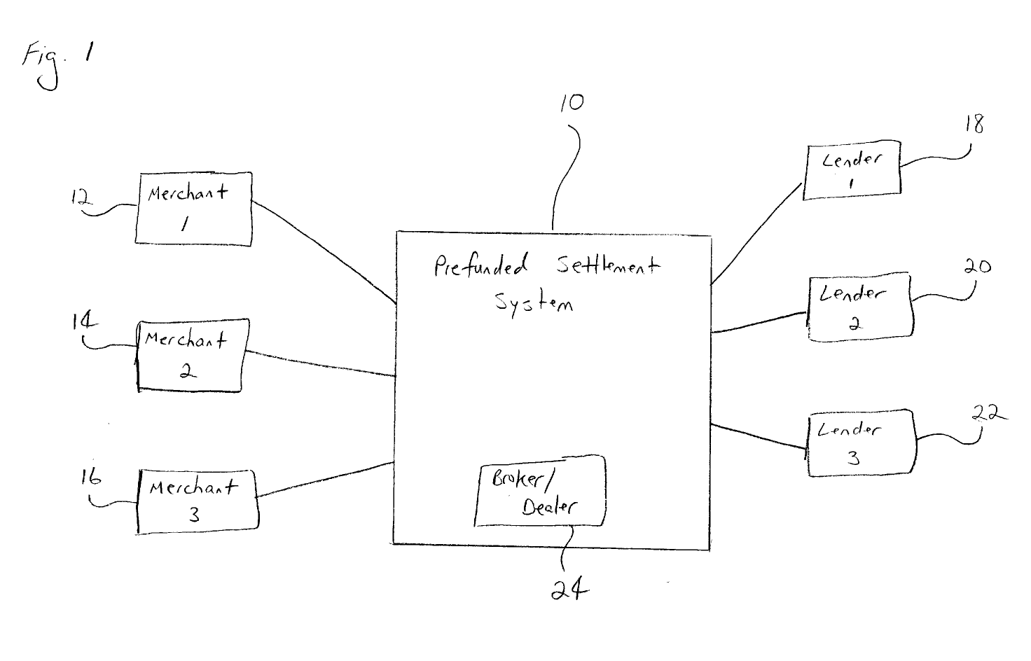

Referring to FIG. 1, the present invention provides a prefunded settlement system 10 which allows low cost working capital to be provided to merchants, while allowing lenders to both assess and diversify risk during the lending process. Merchants, e.g., merchants 12, 14, 16, can elect to participate in pre-funded settlement system 10 as a means of accessing low cost working capital. Lenders, e.g., lenders 18, 20, 22, can also elect to participate in pre-funded settlement system 10 as a means of investing capital where the risks associated with the return of such capital are highly predictable, can be diversified in a predetermined manner and repayment can be accomplished in a plurality of manners. The pre-funded settlement system may also include one or more brokers/dealers 24, which may be utilized to provide a supply of lenders and/or to market/securitize any instruments associated with the lending process.

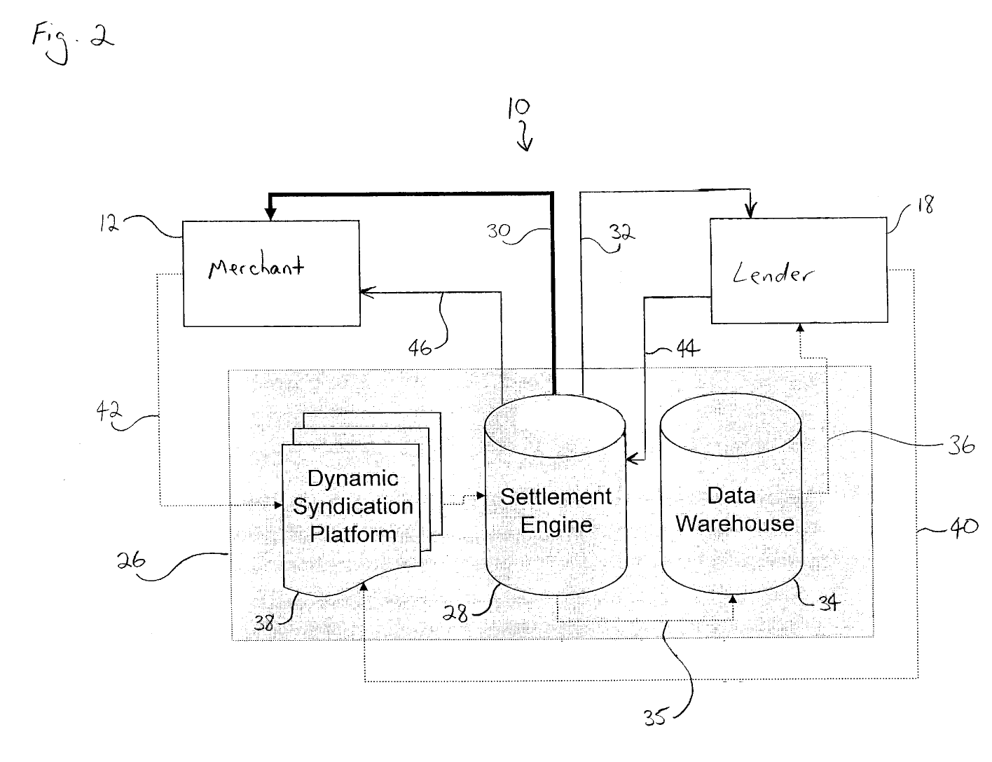

Referring now to FIG. 2, the various components of pre-funded settlement system 10 are shown in greater detail. For simplification, only a single merchant (i.e. merchant 12) and a single funding participant (i.e. lender 18) are shown. System 10 employs a payment network 26, such as the MasterCard Worldwide network. The network includes a settlement engine 28, which handles reconciliation and reporting requirements. More particularly, engine 28 can direct the settlement credit resulting from a card-based retail transaction to a particular account, e.g., merchant 12. This settlement can be moved along pathway 30. Engine 28 can also direct a portion of the settlement credit owed to a particular merchant to a lender 18 as repayment of the advanced funds. This repayment can be moved along pathway 32.

Network 26 further includes a data warehouse 34, which receives and stores historical payment data 35 from settlement engine 28. In particular, data warehouse 34 collects payment history from merchants and industry verticals so that lenders can assess risks and calibrate their participation. In one preferred embodiment, profile data 36 is provided to a funding participant, e.g. lender 18, to allow lender 18 to assess the risk associated with lending to a particular merchant or pool of merchants. In this manner, a lender can pre-select the level of risk that it is willing to incur during the term of such loan. Of course, those skilled in the art will appreciate that higher levels of risk generally have higher rates of return associated therewith. Accordingly, pre-funded settlement system 10 allows a lender or lenders to assess particular payment history for a particular merchant or pool of merchants, and thereafter select a level of participation based upon risk profile, loan duration, or other such factors.

System 10 preferably includes a dynamic syndication platform 38, which may be located inside or outside of network 26. In one preferred embodiment, syndication platform 38 is a software-based application, e.g., a web-based program capable of aggregating the supply and demand from the lenders/borrowers thereby allowing prices to be set in a competitive bid/ask process. More particularly, all of the lending offers, e.g., offer 40 from lender 18, as well as all of the borrowing applications, e.g., application 42 from merchant 12, are directed to syndication platform 38. Platform 38 (which may include broker/dealer 24 or may be operated by broker/dealer 24) aggregates all of the offers and applications, thus balancing the supply of capital from the lenders with the demand for loans from the merchants. The more capital available for loans, the better the rates for the merchants. On the other hand, the less capital available for loans, the higher the rates to the merchants. Once aggregated, capital may be moved from lender 18 to settlement engine 28 along pathway 44, and may be moved from settlement engine 28 to merchant 12 along pathway 46.

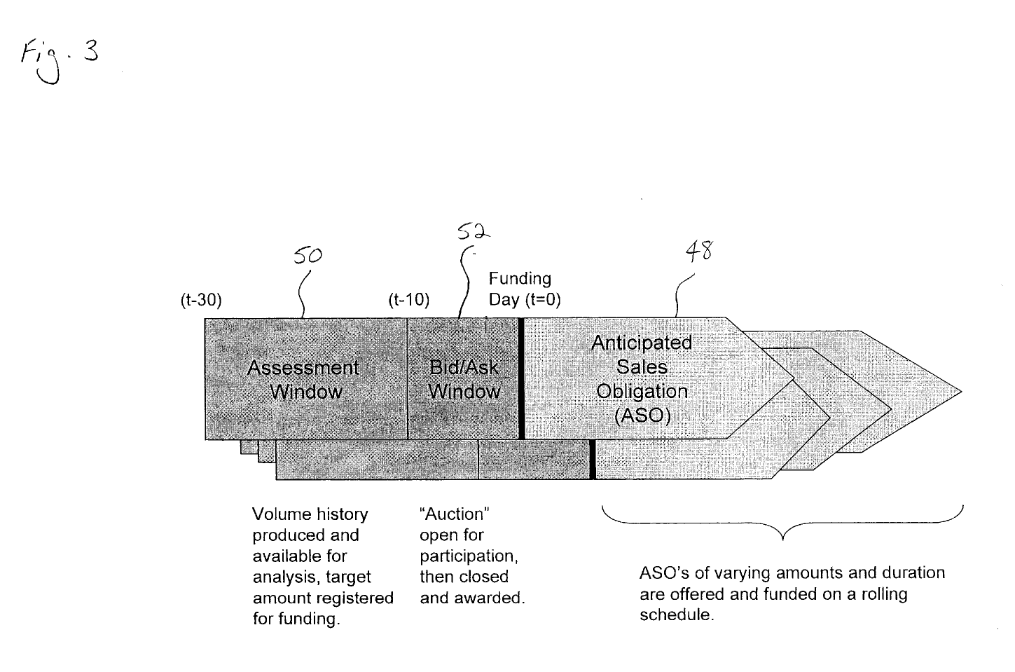

In one preferred embodiment, the bid-ask process is utilized to provide an “anticipated sales obligation” (ASO) 48, as shown in FIG. 3. An ASO is typically a closed-end funding mechanism, which could be securitized by broker/dealer 24. This type of funding mechanism could be directed to specific applications, e.g., a yearly funding plan for retail merchants in advance of the holiday shopping season. It could also be directed to merchants having a higher risk profile in that this funding would be backed by the normally-higher and more predictable holiday sales.

A typical process is described with reference to FIG. 3. An assessment window 50 is made available to potential lenders for a period of time prior to the funding date. In one preferred example, the assessment window is opened from T-30 to T-10. This period of time allows lenders to properly assess and analyze the risk data associated with each of the participating merchants. Next, a bid/ask window 52 is opened for a pre-selected period of time, e.g., from T-10 to T=0. During this period of time, all of the lenders wishing to participate submit a lending offer, while all of the merchants wishing to borrow money submit a borrowing application. In this fashion, ASO's of varying amounts and duration may be offered and funded.

The proceeds of an ASO are paid to a merchant or to a merchant pool at a competitive discount, and daily settlement accrues to participants at par value (less commission) in accordance with an accepted schedule. The notion of a merchant ‘pool’ would exploit the system's ability to aggregate merchants—e.g., within a particular sector or ‘vertical’ category—to cumulate their volume (a scale advantage) and diversify risk (scope advantage) to the benefit of potential investors. This approach would help extend the service to smaller merchants that may not otherwise have access to a competitive working capital facility. Investor repayment is achieved through a connection to the settlement engine, where net settlement can cover multiple programs per investor.

The merchant “pre-funding” transaction can be wired directly into the merchant's account (see pathway 44 of FIG. 2) or, in one preferred embodiment, could be pushed to a purchasing card account, which is connected to the settlement engine through a licensed MasterCard commercial card issuer. In this approach, the merchant would then use the “funded” purchasing card to purchase goods and/or pay obligations in the same way that any card holder would use his credit/debit card to pay for goods/services.

In addition to the closed end ASO funding mechanism described hereinabove, system 10 can also utilize a “rolling” funding program wherein the merchant is advance-funded on a periodic basis (e.g. monthly, quarterly), and the lender would draw a daily settlement in proportion to their participation until such obligation is satisfied. This rolling program could be directed to higher quality merchants, and may or may not utilize a broker/dealer. In one application, the program would use a dynamic pricing mechanism to discount the funding according to some risk-adjusted rate, and in accordance with the supply/demand for funds. For example, if a merchant is advanced 50% of its estimated anticipated sales for a 30 day period, settlement could be (a) for a specific amount of receipts each day wherein shortfalls are carried forward, or (b) total receipts would be settled to investors daily until the obligation is satisfied.

In scenario (a), investors may have concerns about daily shortfalls and expect to be compensated for that likelihood in the offer rate. If the duration of the funding period is longer, or if the “percent-to-total” sales is higher (i.e., >50%), this would increase the probability of daily shortfalls, which would likely be reflected in the pricing. In scenario (b), where total receipts accrue to investors, the key pricing factor involves the variability in the days required to close out the obligation. If the cash flow cycle can be predicted very accurately, the ‘risk premium’ will be small. Conversely, if there is uncertainty (i.e., the obligation could take between 12 and 20 days to hit the pre-funded amount based on historical data), investors would seek compensation in the offer rate.

The mentioned “rolling” funding program can utilize various multi-day funding programs, e.g., 30 day, 60 day, 90 day or other length programs. For example, if system 10 utilizes a 30 day program, such a program might include three consecutive 30 day cycles. Likewise, a 60 day program might include two consecutive 60 day cycles. A 90 day program might include a single 90 day cycle. Following each funding cycle, a “true up” phase would be implemented to update the program to then current market rates. It is contemplated herein that these funding cycles could be packaged and marketed as investment vehicles, e.g., an annuity. Such packaging/marketing could be overseen and/or underwritten by broker/dealer 24.

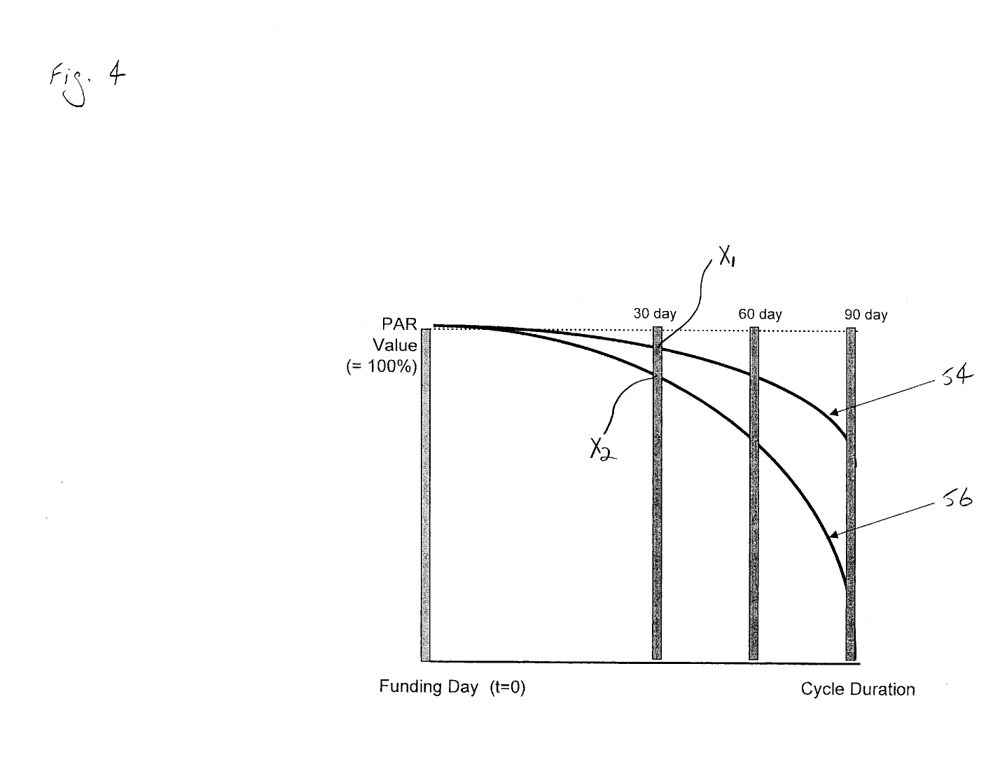

Referring now to FIG. 4, system 10 allows the lender to readily calculate a discount factor to be used during the subsequent lending activity. This factor is typically a function of 1) duration, 2) cost of capital, and 3) uncertainty in the anticipated sales volume. For example, a “more reliable volume estimate” 54 would have a different discount factor than a “less reliable volume estimate” 56. In other words, assuming par value at day 0=100, a lender may be willing to lend X₁ percentage for a 30 day cycle for estimate 54, but only X₂ percentage for a 30 day period for estimate 56, wherein X₂ is a greater number than X₁ resulting in a smaller amount of money to be lent. For example, if X₁=5% and X₂=10%, then a lender may be willing to lend 95% of par value to the merchant having the more reliable volume estimate 54, while only be willing to lend 90% of par value to the merchant having the less reliable volume estimate 56.

In one preferred embodiment, system 10 utilizes a 30/50 funding mechanism, which means that the system uses a 30 day funding cycle, and provides 50% of the anticipated sales to the merchant at day 1 of the funding cycle. Prior to funding, target sales level for particular payments (e.g. MC branded cards) for months 1 to X are “socialized” using historical data associated with that merchant i.e., prospective lenders are provided detailed cash-flow histories of the merchants. On Day 1, 50% of the merchant's anticipated sales are credited to the merchant's account from the funding provided by the lenders participating in the program. From Day 1 to Day 25, 50% of the merchant's settlement is diverted to the lenders for repayment, proportional to their active participation in the program. From Day 25 to Day 30, a “true-up” period is implemented, taking into account “higher than/lower than” projected sales. The monthly cycle is thereafter repeated. Of course, the particular number of days described hereinabove can be adjusted as necessary. For example, the number of days could be adjusted to follow the actual number of calendar days in a month. In addition, the number of days for the true-up period could be made longer or shorter. Finally, the length of period of the funding cycle could be varied to any amount of days, and the amount of future projected sales to be advanced to the merchant could be more or less than 50%.

Merchants will certainly recognize that access to regular funds (i.e., liquidity) allows them to timely fulfill their monthly obligations. Moreover, the money being saved by the merchant which would otherwise be tied up in cost of capital compensates for any discount rate imposed on such merchant for participating in the program. Finally, such a program may provide the merchant with an opportunity to achieve rebate/discounts through mutually agreed to volume/share goals.

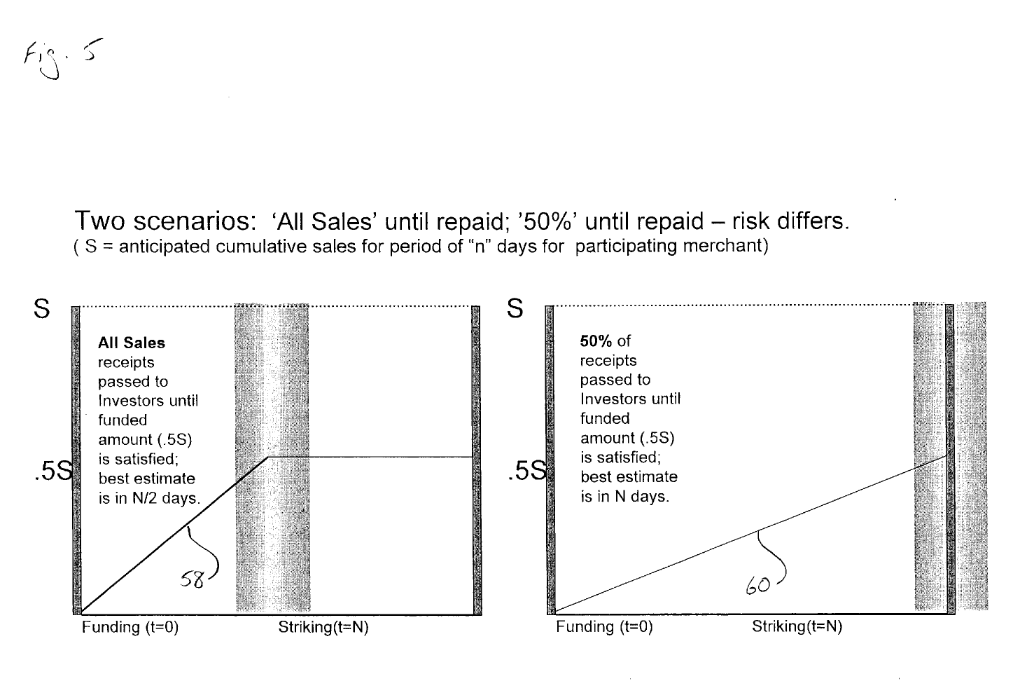

As discussed hereinabove, repayment of advanced funding can be accomplished in several ways, including the two examples shown in FIG. 5. In the first example, all sales receipts are directed to the lender(s) until the funded amount is satisfied, and is graphically depicted as curve 58. In the second example, 50% of the sales receipts are directed to the lender(s) until the funded amount is satisfied, and is graphically depicted as curve 60.

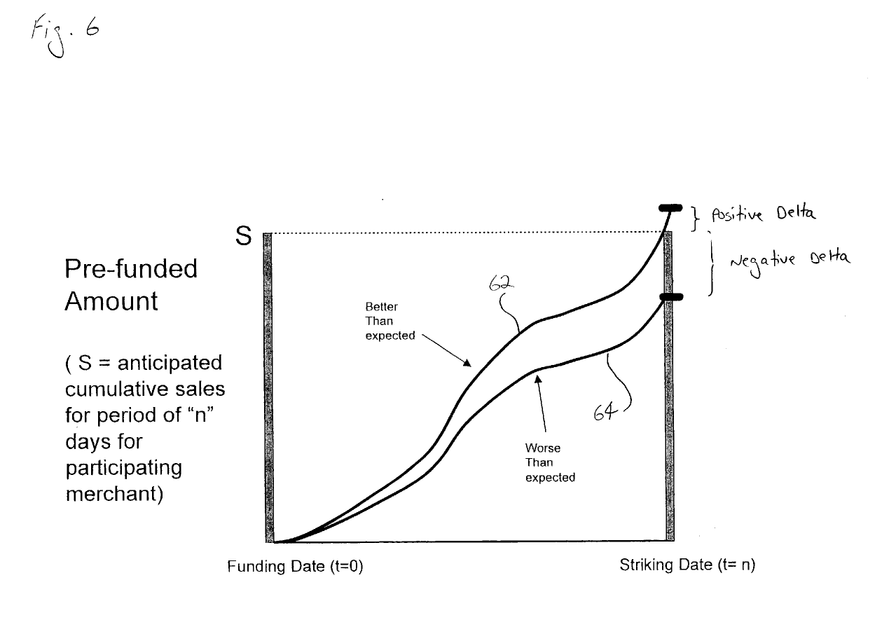

Each funding period is typically ended with a “true-up” phase. This true-up phase is illustrated with reference to FIG. 6 wherein S is equal to the anticipated cumulative sales. In other words, the merchant would have been advanced an amount of money equal to value S. Accordingly, if at the close of the funding period, the merchant's actual sales are represented by “Better than Expected” curve 62, than the merchant has, in effect, overpaid the lender, and is entitled to a refund from such lender. If, on the other hand, the merchant's sales are represented by “Worse than Expected” curve 64, then the merchant has in effect underpaid the lender, and additional monies are due to such lender.

### EXAMPLE

A grocery chain receives funds on 50% of its expected monthly card volume on the first Monday of each month through participation in a 50/30 program. The grocery chain then uses the cash to cover monthly payroll, rent, utilities and other costs which oftentimes require such chain to use a credit line, or to delay payment. The matching of borrowers with lenders, and bids with asks, allows funds to be advanced to the grocery chain at an attractive discount-to-par value. In one preferred embodiment, the discount is set at a competitive rate, where historical data supplied by a merchant processor/network (e.g., MasterCard) is used by participating investors to price the risk. The grocery chain may participate in an “industry vertical program” which aggregates demand across grocery merchants to achieve a more favorable “pool” rate, i.e., by increasing the number of merchants, the risk associated with any particular merchant is reduced. The network (e.g., MasterCard) directs a portion of the card receipts to the investor pool consistent with the program terms, while also handling the month end reconciliation. The system operator preferably charges a commission on volume flowing through the system, preferably with no exposure to risk, such risk being born by the lenders and brokers/dealers. If the grocery chain exceeds the target volume in a particular month, they can be eligible for an incentive deal which provides a reduction in the funding rate for the subsequent period. Within the stores of the grocery chain, customers are preferably prompted at the point of sale to pay with a particular branded card, e.g., through preferred checkout services and/or paypass lanes.

It will be appreciated that the present invention has been described herein with reference to certain preferred or exemplary embodiments. The preferred or exemplary embodiments described herein may be modified, changed, added to or deviated from without departing from the intent, spirit and scope of the present invention, and it is intended that all such additions, modifications, amendments and/or deviations be included in the scope of the present invention.

What is claimed is:

1. A method of advancing cash to merchants participating in a consumer card-based payment network, comprising the steps of:
aggregating within said payment network all lending offers from prospective lenders with all borrowing applications from said merchants to match the supply of capital from said lenders with the demand for loans from said merchants whereby an effective interest rate can be determined;
advancing a preselected amount of cash to at least one qualified merchant at said effective interest rate; and
repaying said lenders by diverting a predetermined portion of funds travelling through said payment network and which are payable to said qualified merchant to said lenders.

2. The method according to claim 1, further comprising the step of providing historical sales data associated with at least one of said merchants to at least one of said prospective lenders to allow said at least one lender to assess the risk associated with lending to said at least one merchant.

3. The method according to claim 2, wherein said sales data is associated with a pool of merchants, and
further comprising the step of assessing the risk associated with lending to said pool of merchants.

4. The method according to claim 3, wherein said borrowing application requests a specified loan duration, and
further comprising the step of assessing the risk associated with lending an amount of capital for said specified loan duration.

5. The method according to claim 2, further comprising the step of:
qualifying a merchant by matching the risk profile associated with said merchant to a prospective lender willing to accept said risk profile.

6. The method according to claim 5, further comprising the step of:
establishing said effective interest rate based upon said risk profile and loan duration.

7. The method according to claim 1, further comprising the steps of:
receiving within said payment network a plurality of lending offers from a plurality of prospective lenders; and
receiving within said payment network a plurality of borrowing applications from said merchants;

8. The method according to claim 7, further comprising the steps of:
providing a software-based dynamic syndication platform for receipt of said lending offers and said borrowing applications, said aggregating step being accomplished by said platform; and
accessing cash from at least one of said prospective lenders for advancing to said qualified merchant.

9. The method according to claim 1, further comprising the steps of:
providing a broker for aggregating said lending offers with said borrowing applications; and
securitizing the loans made to said merchants.

10. The method according to claim 1, further comprising the step of:
pushing said preselected amount of cash to a purchasing card account associated with said qualified merchant.

11. The method according to claim 1, further comprising the step of:
discounting said preselected amount of cash via a dynamic pricing mechanism according to a risk-adjusted rate; and
wherein said advancing step is performed on a periodic basis.

12. The method according to claim 11, wherein said discounting step includes the further step of:
calculating a discount factor as a function of loan duration, cost of capital and uncertainty in anticipated sales volume.

13. The method according to claim 12, further comprising the step of:
truing-up the outstanding balance relating to said preselected amount of cash following a predetermined funding period.

14. The method according to claim 1, wherein said aggregating step includes the further successive steps of:
opening an assessment window for a preselected period of time prior to funding for assessment of risk by said prospective lenders and for registering a target funding amount;
closing said assessment window; and
opening an auction window to match merchants with compatible risk-accepting lenders.

15. The method according to claim 1, further comprising the step of awarding said qualified merchant with a rebate or discount in response to the sales of said qualified merchant reaching a predetermined level.

16. The method according to claim 15, further comprising the step of prompting a customer at the point-of-sale to pay with a particular branded card.

17. The method according to claim 16, wherein said prompting step includes the further step of:
offering preferred checkout service when paying with a particular branded card.

18. A system for advancing cash to a merchant participating in a consumer card-based payment network, comprising:
a payment network for handling consumer card-based retail transactions, said network including
1) a settlement engine for handling reconciliation and reporting requirements,
2) a data warehouse for collecting and storing payment history from merchants participating in said network, and
3) a dynamic syndication platform for receiving lending offers from prospective lenders and for receiving borrowing application from participating merchants;
wherein said platform is configured to aggregate said lending offers with said borrowing applications to match the supply of capital from said lenders with the demand for loan from said merchants whereby an effective interest rate may be determined;
wherein said settlement engine is configured to advance a preselected amount of cash to at least one qualified merchant at said effective interest rate;
and wherein said settlement engine is configured to divert a predetermined portion of funds travelling through said network and which are payable to said qualified merchant to said lender.

19. A system according to claim 18, wherein said data warehouse is configured to supply said prospective lenders with historical sales data associated with at least one of said merchants to allow said lenders to assess the risk associated with lending to said at least one merchant risk assessment to be undertaken.

20. The system according to claim 19, wherein said dynamic syndication platform is a secure web-based program allowing access by approved lenders and merchants.
